(19) United States
(12) Patent Application Publication
(10) Pub. No.: US 2026/0319427 A1
(43) Pub. Date: Oct. 15, 2026

(54) OPTICAL SCANNING APPARATUS AND IMAGE FORMING APPARATUS

(71) Applicant: CANON KABUSHIKI KAISHA, Tokyo (JP)

(72) Inventors: HIROYUKI FUKUHARA, Shizuoka (JP); ICHIRO FUKADA, Shizuoka (JP)

(21) Appl. No.: 19/635,247

(22) Filed: Mar. 31, 2026

(30) Foreign Application Priority Data
Apr. 14, 2025 (JP) 2025-066553

(51) Int. Cl. G03G 21/16; G03G 15/00; G03G 15/04

(52) U.S. Cl. CPC G03G 21/1633; G03G 15/04072; G03G 15/0409; G03G 15/80; G03G 2215/0404; G03G 2221/169

(57) ABSTRACT

An optical scanning apparatus includes a light deflector including a rotatable polygonal mirror, a motor, a substrate, and a connecting portion; a casing including a bottom and an open portion; and a lid. The lid is provided with an opening through which the electric wire passes and which enables connection of the electric wire to the connecting portion in a state in which the lid is mounted to the casing. When a central portion of the reflecting surface of the rotatable polygonal mirror in the rotational axis direction, which is a flat plane perpendicular to the rotational axis direction is a rotation locus flat plane, the opening is positioned on a side opposite from the bottom of the casing in the rotational axis direction with the rotation locus flat plane as a boundary.

### BACKGROUND

### Field of the Technology

The present disclosure relates to an optical scanning apparatus for performing scanning by deflecting laser light, and an image forming apparatus, such as a copying machine, a printer, a facsimile machine, including the optical scanning apparatus and of an electrophotographic type.

### Description of the Related Art

The optical scanning apparatus includes optical members such as a light deflector provided with a rotational polygonal mirror (polygon mirror), a lens, a mirror. Further, the optical scanning apparatus performs scanning by deflecting the laser light by rotating the rotational polygonal mirror of the light deflector, so that the laser light is formed into an image on a surface-to-be-scanned of a photosensitive member or the like through the lens and the mirror.

The optical members of the optical scanning apparatus are accommodated inside a housing in consideration of contamination of the rotational polygonal mirror or the like and operating sound with rotation of the rotational polygonal mirror. The housing includes, in general, an optical box (casing) in which the optical members are accommodated, and a lid for covering the optical box. The housing is provided with a through hole through which communication between an inside and an outside of the housing is established for driving the light deflector by transmitting a signal from a circuit board, provided to an image forming apparatus main body, to the light deflector. Further, through the through hole, a harness (electric wire) for transmitting the signal to the light deflector is connected to the light deflector.

In Japanese Patent No. 6433118, the following constitution is disclosed as a constitution for suppressing flowing-in of air contaminated with dust to an inside the housing through the through hole while enabling connection of the harness to the light deflector even after the lid is mounted to the optical box. That is, in the through hole of the lid, a mounting portion for mounting an elastic member such as a sponge is provided. The mounting portion is recessed so as to approach toward a connector of the light deflector, and the elastic member is engaged in this mounting portion.

Further, in Japanese Laid-Open Patent Application (JP-A) No. 2003-262814, the following constitution is disclosed as a constitution for improving an assembling property while considering contamination of the optical members. That is, a holding portion for holding a relay connector for connecting a harness connected to the light deflector and a harness from the circuit board provided to the image forming apparatus main body before the lid is mounted to the optical box is provided to the optical box.

However, in recent years, due to downsizing of the light deflector, there is a tendency that a distance, between the rotational polygonal mirror and the connector of the light deflector to which the harness is connected, in a radial direction of the rotational polygonal mirror becomes short.

For that reason, as in the constitution disclosed in Japanese Patent No. 6433118, when the mounting portion recessed so as to approach toward the connector of the light deflector in order to mount the elastic member thereto is provided to the lid of the optical box, a distance between the mounting portion and the rotational polygonal mirror in the radial direction of the rotational polygonal mirror becomes short. Further, air (wind) generated by rotation of the rotational polygonal mirror blows against the mounting portion, and thus a vortex of the air is generated, so that pressure of the air is changed by this vortex and thus noise generated by vibration of the air, i.e., a so-called wind noise becomes large.

In the constitution disclosed in JP-A No. 2003-262814, there is no mounting portion in the constitution disclosed in Japanese Patent No. 6433118, and therefore, there is no increase in wind noise as described above. However, a constitution in which the harness is passed through the lid of the optical box is not employed, and therefore, there is a need to provide an assembling step such that the harness is connected to the light deflector before the lid is mounted to the optical box, so that there is a room for improvement in assembling property. Further, in the case of the constitution disclosed in JP-A No. 2003-262814, an optical scanning apparatus is required to be manufactured and shipped in a state in which the optical scanning apparatus is provided with the harness, and a relay connector is needed, and therefore, the optical scanning apparatus is disadvantageous in terms of a conveying property and a cost.

### SUMMARY

Therefore, the present disclosure is directed to suppress wind noise due to rotation of a rotational polygonal mirror in a constitution in which a harness (electric wire) is passed through a lid of an optical box.

An aspect of the present disclosure provides an optical scanning apparatus comprising: a light deflector configured to deflect laser light emitted from a light source, the light deflector including a rotatable polygonal mirror having a reflecting surface for reflecting the laser light, a motor for driving the rotatable polygonal mirror, a substrate on which an electric circuit for driving the motor is formed and on which the motor is mounted, and a connecting portion to which an electric wire is connected; a casing configured to accommodate the light deflector, the casing including a bottom for supporting the light deflector and an open portion opposing the bottom in a rotational axis direction of the rotatable polygonal mirror; and a lid configured to cover the open portion of the casing, wherein the lid is provided with an opening through which the electric wire passes and which enables connection of the electric wire to the connecting portion in a state in which the lid is mounted to the casing, and wherein when a central portion of the reflecting surface of the rotatable polygonal mirror in the rotational axis direction, which is a flat plane perpendicular to the rotational axis direction is a rotation locus flat plane, the opening is positioned on a side opposite from the bottom of the casing in the rotational axis direction with the rotation locus flat plane as a boundary.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus.

FIG. 2 is a perspective view showing an internal constitution of an optical scanning apparatus.

FIG. 3 is a perspective view of an outer appearance of the optical scanning apparatus.

FIG. 4 is a schematic sectional view of the optical scanning apparatus.

FIG. 5 is a schematic sectional view of an optical scanning apparatus of another embodiment.

FIG. 6 is a schematic sectional view of an optical scanning apparatus of a further embodiment.

FIG. 7 is a schematic view showing an example of a constitution of an elastic member and a mounting portion.

FIG. 8 is a schematic sectional view of an optical scanning apparatus of a comparison example.

### DESCRIPTION OF THE EMBODIMENTS

In the following, an optical scanning apparatus and an image forming apparatus according to the present disclosure will be specifically described.

### Embodiment 1

### Image forming apparatus

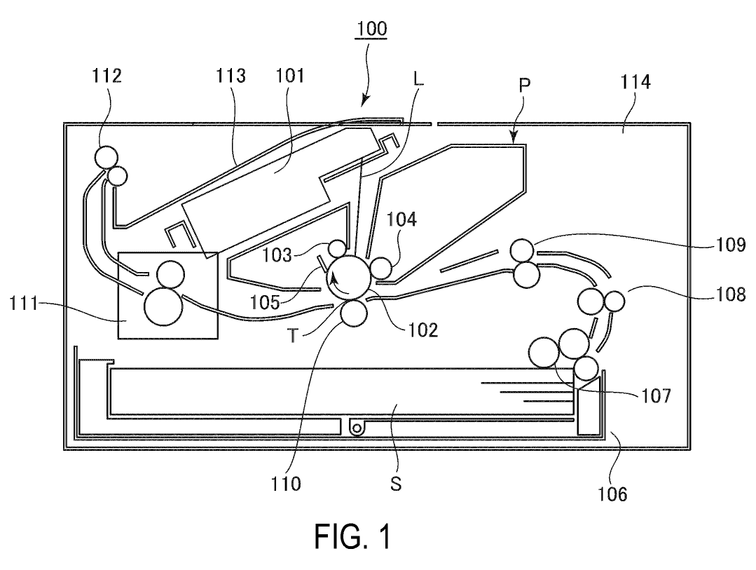

FIG. 1 is a schematic sectional view of an image forming apparatus 100 of this embodiment. The image forming apparatus 100 of this embodiment is a laser beam printer capable of forming a black monochromatic image on a sheet-like recording material S by using an electrophotographic process.

The image forming apparatus 100 includes an optical scanning apparatus (laser scanner) 101. Further, the image forming apparatus 100 includes a photosensitive drum 102 which is a rotatable drum-shaped (cylindrical) photosensitive member (electrophotographic photosensitive member) as an image bearing member, and a charging roller 103 which is a roller-shaped charging member as a charging means. In addition, the image forming apparatus 100 includes a developing device 104 as a developing means, and a cleaning device 105 as a cleaning means. The photosensitive drum 102, and as process means actable on the photosensitive drum 102, the charging roller 103, the developing device 104, and the cleaning device 105 are integrally assembled into a cartridge and constitute a process cartridge P detachably mountable to an image forming apparatus main body 114. Further, image forming apparatus 100 includes a feeding cassette 106 as a feeding portion, a feeding roller 107 as a feeding member, conveying rollers 108 and 109 as a conveying member, and a transfer roller 110 which is a roller-shaped transfer member as a transfer means. The transfer roller 110 is pressed toward the photosensitive drum 102, and forms a transfer portion (transfer nip) T which is a contact portion between the photosensitive drum 102 and the transfer roller 110. Further, the image forming apparatus 100 includes a fixing device 111 as a fixing means, a discharging roller 112 as a discharging member, and a discharge tray 113 as a discharge portion.

The photosensitive drum 102 is rotated in a clockwise direction in FIG. 1. A surface of a rotating photosensitive drum 102 is electrically charged uniformly to a predetermined polarity (negative polarity in this embodiment) and a predetermined potential by the charging roller 103. The charged surface of the photosensitive drum 102 is scanned and exposed to light on the basis of image in function by the optical scanning apparatus 101, so that an electrostatic latent image (electrostatic image) is formed on the photosensitive drum 102. The optical scanning apparatus 101 emits a laser beam flux L, so that the photosensitive drum 102 is irradiated with the laser beam flux L. By irradiating the photosensitive drum 102 with the laser beam flux L, a surface electric charge of the photosensitive drum 102 is attenuated, so that the electrostatic latent image is formed on the photosensitive drum 102. The electrostatic latent image formed on the photosensitive drum 102 is developed (visualized) by being supplied with toner as a developer by the developing device 104, so that a toner image (toner picture, developer image) is formed on the photosensitive drum 102. In this embodiment, the photosensitive drum 102 is exposed to light after being charged uniformly, so that to an exposed portion on the photosensitive drum 102 lowered in a absolute value of the potential, the toner charged to the same polarity (negative polarity in this embodiment) as a charge polarity of the photosensitive drum 102 is deposited. In this embodiment, a normal charge polarity of the toner, which is a principal charge polarity of the toner during development is the negative polarity.

On the other hand, the recording materials S such as paper accommodated in the feeding cassette 106 are separated and fed one by one by the feeding roller 107. The fed recording material S is conveyed to a downstream side toward the transfer portion T by the conveying rollers 108 and 109. The toner image formed on the photosensitive drum 102 is transferred, in the transfer portion T by the action of the transfer roller 110, onto the recording material S nipped and conveyed by the photosensitive drum 102 and the transfer roller 110. During the transfer, to the transfer roller 110, a transfer voltage of an opposite polarity (positive polarity) to the normal charge polarity of the toner is applied. The recording material S on which the toner image is transferred is further conveyed to the downstream side toward the fixing device 111. The fixing device 111 includes a rotatable fixing member provided with a heater therein and a rotatable pressing member press-contacting the rotatable fixing member, and heats and presses the recording material S carrying thereon an unfixed toner image while conveying the recording material S by the rotatable fixing member and the rotatable pressing member, whereby the toner image is fixed on the recording material S.

Thereafter, the recording material S on which the toner image is fixed is discharged (output) onto the discharge tray 113, provided at an outer portion (upper portion) of the image forming apparatus main body 114 by the discharging roller 112. Further, toner remaining on the photosensitive drum 102 without being transferred onto the recording material S is removed and collected from the photosensitive drum 102 by the cleaning device 105.

### Optical scanning apparatus

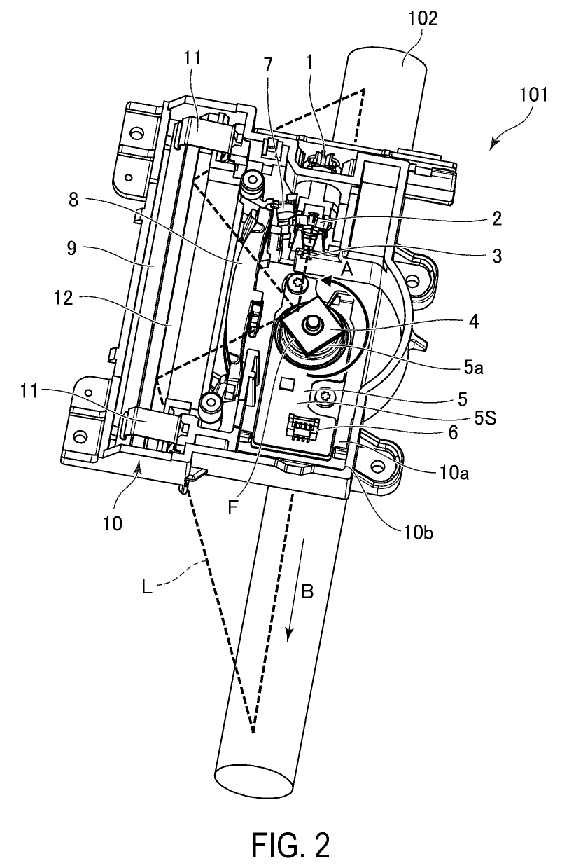

FIG. 2 is a perspective view showing an internal constitution of the optical scanning apparatus 101 in this embodiment. The optical scanning apparatus 101 irradiates the surface of the photosensitive drum 102 with laser light by deflecting the laser light and by scanning the photosensitive drum surface with the laser light, so that the electrostatic latent image is formed on the photosensitive drum 102.

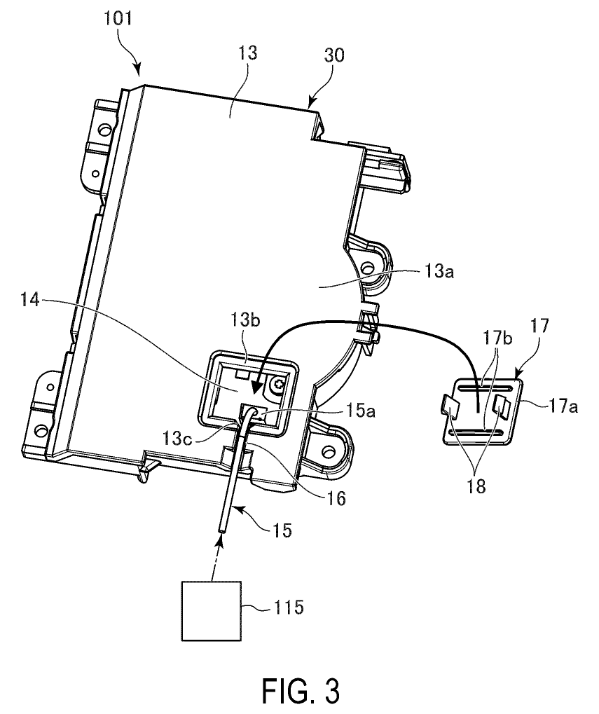

The optical scanning apparatus 101 includes a semiconductor laser unit 1 as a light source for emitting the laser beam flux L, an anamorphic collimator lens 2 obtained by integrally molding a collimator lens and a cylindrical lens, and a main scanning diaphragm 3 constituted by a groove. Further, the optical scanning apparatus 101 includes a light deflector 5 as a light deflecting means. The light deflector 5 includes a rotational polygonal mirror (polygon mirror) 4 provided with a plurality of reflecting surfaces F, a motor 5a as a driving source for driving the rotational polygonal mirror 4, and a connector 6 which is a connecting portion to which a harness 15 (FIG. 3) for transmitting a signal to the light deflector 5 is connected. The connector 6 is provided on a substrate 5S on which the motor 5a is mounted. On the substrate 5S, an electric circuit for driving the motor 5a is formed. The substrate 5S is a part of the light deflector 5. Further, the optical scanning apparatus 101 includes a BD sensor 7 as a detecting means for detecting the laser beam flux L which is deflected by the light deflector 5 and with which the photosensitive drum surface is scanned in order to determine a writing position (writing start position) on the surface of the photosensitive drum 102. Further, the optical scanning apparatus 101 includes a scanning lens 8 as an imaging means for forming the laser beam flux L subjected to deflection scanning into an image on the surface of the photosensitive drum 102, and a reflection mirror 9 for reflecting the laser beam flux L, transmitted through the scanning lens 8, toward the surface of the photosensitive drum 102.

Further, the optical scanning apparatus 101 includes an optical box 10 as a casing for accommodating respective optical members including the semiconductor unit 1, the anamorphic collimator lens 2, the main scanning diaphragm 3, the light deflector 5, the BD sensor 7, the scanning lens 8, and the reflection mirror 9. Further, the optical scanning apparatus 101 includes a lid 13 (FIG. 3) mounted to the optical box 10 so as to cover the optical box 10 and a small lid 17 (FIG. 3) mounted to the lid 13 so as to close a through hole 14 provided in the lid 13 and described later. In this embodiment, the optical box 10, the lid 13, and the small lid 17 are formed by injection molding with use of a black resin. Further, the optical scanning apparatus 101 is provided with a reflection mirror pressing spring 11 for urging the reflection mirror 9 toward the optical box 10. Further, the optical box 10 is provided with an emission port 12 through which the laser beam flux L passes. The above-described respective optical members are accommodated inside a space closed by the optical box 10 and the lid 13 (and the small lid 17) by mounting of the lid 13 to the optical box 10 after being fixed to the optical box 10. A housing 30 of the optical scanning apparatus 101 is constituted by the optical box 10 and the lid 13 and the small lid 17).

Here, a direction (direction substantially parallel to a rotational axis direction of the photosensitive drum 102) in which the photosensitive drum 102 is scanned with the laser beam flux L by the light deflector 5 is defined as a main scanning direction, and a direction (direction substantially parallel to a surface movement direction of the photosensitive drum 102) perpendicular to the main scanning direction is defined as a sub-scanning direction.

An operation of the optical scanning apparatus 101 will be described. The laser beam flux L emitted from the semiconductor laser unit 1 is made substantially parallel light or converged light in the main scanning direction and is made converged light in the sub-scanning direction, by the anamorphic collimator lens 2. Then, the laser beam flux L is restricted in light flux width in the main scanning direction by the main scanning diaphragm. Incidentally, a light flux width of the sub-scanning direction is restricted by an unshown aperture hole (sub-scanning diaphragm) provided upstream of the anamorphic collimator lens 2. The light flux passed through the sub-scanning diaphragm, the anamorphic collimator lens 2, and the main scanning diaphragm is formed into an image, in a focal line shape extending long in the main scanning direction, on the reflecting surface F of the rotational polygonal mirror 4.

The laser beam flux L imaged on the reflecting surface F of the rotational polygonal mirror 4 is subjected to the deflection scanning by the rotational polygonal mirror 4 rotating in an arrow A direction (counterclockwise direction) in FIG. 2. At this time, the light deflector 5 drives the motor 5a depending on an electric signal supplied from a circuit board (controller) 115 (FIG. 3), provided to the image forming apparatus main body 114, to the connector 6 through the harness 15 (FIG. 3). The motor 5a is rotated (driven), whereby the rotational polygonal mirror 4 is rotated. That is, to one end of the harness 15, a connector portion 15a (FIG. 3) connected to the connector 6 of the light deflector 5 is provided. The connector portion 15a of the harness 15 is inserted into the connector 6 of the light deflector 5, so that the harness 15 is connected to the light deflector 5.

Further, the other end of the harness 15 is connected to the circuit board 115 as an output portion provided to the image forming apparatus main body 114. Further, a signal for driving the motor 5a of the light deflector 5 is output from the circuit board 115 and is transmitted to the light deflector 5 through the harness 15. Incidentally, the harness 15 may be bundled wires such that a plurality of electric wires (cords, cables) are bundled or may also be a single electric wire (cord, cable). With the laser beam flux L subjected to the deflection scanning, the BD sensor 7 is scanned in the main scanning direction.

Next, the laser beam flux L subjected to the deflection scanning is reflected by the reflection mirror 9 after transmitted through the scanning lens 8, and is emitted to an outside of the optical scanning apparatus 101 through the emission port 12. With the emitted light flux (laser beam flux) L, the photosensitive drum surface is scanned in an arrow B direction (main scanning direction) in FIG. 2 while the light flux L is finally formed into an image in a spot on the photosensitive drum 102. Further, the cylindrical photosensitive drum 102 is rotationally driven around an axis thereof, whereby the surface of the photosensitive drum 102 is scanned with the laser beam flux L in the sub-scanning direction.

By the above-described operation of the optical scanning apparatus 101, the electrostatic latent image depending on the image information is formed on the surface of the photosensitive drum 102 uniformly charged by the charging roller 103 (FIG. 1).

FIG. 3 is a perspective view of the optical scanning apparatus 101 in a state in which the lid 13 is mounted to the optical box 10. FIG. 3 shows a state in which the small lid 17 for closing a through hole 14 described later is assembled to the lid 13.

The optical box 10 is provided with a bottom (surface) 10a for supporting the light deflector 5, and an open portion 10b is provided in a position opposite from the bottom 10a in a rotational axis direction of the rotational polygonal mirror 4. The lid 13 is mounted to the optical box 10 so as to cover the open portion 10b, so that the above-described optical members are accommodated inside a space closed by the optical box 10 and the lid 13 (and the small lid 17), i.e., inside the housing 30. The lid 13 is mounted to the optical box 10 for the purposes of preventing the laser beam flux L from being exposed to an outside of the optical scanning apparatus 101, protecting the respective optical members from contamination, and preventing operating sound generated by rotational drive of the rotational polygonal mirror 4.

The lid 13 is provided with the through hole 14 which is an opening penetrating through the lid 13 so as to enable access to the connector 6 of the light deflector 5 from the outside of the optical scanning apparatus 101 even in the state in which the lid 13 is mounted to the optical box 10. Further, through the through hole 14, the harness 15 for establishing communication of an electric signal with the light deflector 5 is connected to the light deflector 5. That is, the through hole 14 is provided in a region including a region opposing the connector 6 of the light deflector 5 in the rotational axis direction of the rotational polygonal mirror 4. That is, when the optical scanning apparatus 101 in the state in which the lid 13 is mounted to the optical box 10 is viewed in the rotational axis direction of the rotational polygonal mirror 4, the connector 6 is disposed in a position where the connector 6 overlaps with the through hole 14. The through hole 14 establishes communication between an inside and an outside of the housing 30. For that reason, even in a state in which the lid 13 is mounted to the optical box 10 and an inside of the optical box 10 is covered by the lid 13, the harness 15 is inserted into the inside of the housing 30, so that the connector portion 15a provided in an end portion of the harness 15 can be connected to the connector 6.

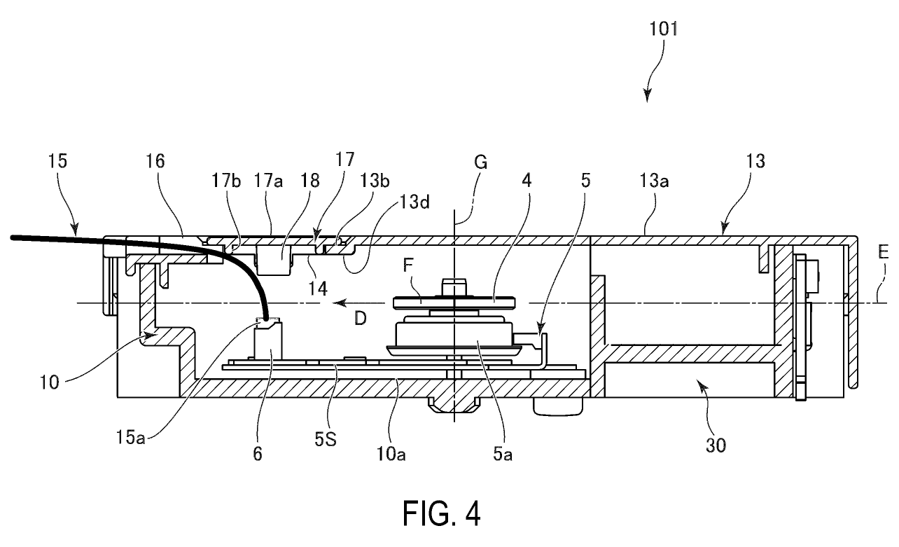

Further, the light deflector 5 is fixed on the bottom 10a (FIG. 2, FIG. 4) having a substantially planar shape substantially perpendicular to the rotational axis direction of the rotational polygonal mirror 4 in the optical box 10. In addition, the light deflector 5 includes the connector 6 in a position on one end portion side of the housing 30 with respect to the main scanning direction than a position of a rotational axis G of the rotational polygonal mirror 4 is. The connector 6 is provided so that the connector portion 15a of the harness 15 is detachably mountable thereto from a side opposite from the bottom 10a of the optical box 10 along the rotational axis direction of the rotational polygonal mirror 4. On the other hand, the lid 13 has an outer surface 13a which constitutes an outer surface of the housing 30 and which has a substantially planar shape substantially perpendicular to the rotational axis direction of the rotational polygonal mirror 4. Further, the lid 13 includes a stepped portion 13b which is recessed so as to approach from the outer surface 13a toward the bottom 10a of the optical box 10 along the rotational axis direction of the rotational polygonal mirror 4 and which has a substantially planar shape substantially perpendicular to the rotational axis direction of the rotational polygonal mirror 4. In this embodiment, the stepped portion 13b is provided so as to constitute substantially rectangular four sides in the case where the stepped portion 13b is viewed along the rotational axis direction of the rotational polygonal mirror 4. Further, the through hole 14 is provided so as to be enclosed by this stepped portion 13b. That is, in this embodiment, the through hole 14 is provided in a flat surface of the stepped portion 13b lowered by one stage from a flat surface of the outer surface 13a of the lid 13.

Further, the lid 13 is provided with a groove portion 16 for guiding (holding) the harness 15 mounted to the optical scanning apparatus 101. The groove portion 16 is recessed so as to approach from the outer surface 13a toward the bottom 10a of the optical box 10 and extends toward the outside of the housing 30 along the main scanning direction. Of the stepped portion extending in a direction substantially perpendicular to the main scanning direction, in the stepped portion 13b close to the outside of the housing 30, a cut-away portion 13c capable of receiving the harness 15 is formed so as to be continuous to the groove portion 16. The harness 15 extending from the connector portion 15a toward the circuit board 115 side passes through the cut-away portion 13c and is guided (held) by the groove portion 16, and then is pulled out toward the outside of the housing 30 (optical scanning apparatus 101). The groove portion 16 is constituted so as to be capable of restricting a position of the harness 15 while holding the harness 15. Specifically, a width of the groove portion 16 is, for example, set somewhat narrower than a thickness of the harness 15 constituted by a single electric wire (cable, cord), and the harness 15 is press-fitted in the groove portion 16, so that the harness 15 can be held in the groove portion 16. Incidentally, the cut-away portion 13c may have a function of restricting the position of the harness 15 or may be constituted, so that the harness 15 can be simply passed through the cut-away portion 13c. The harness 15 is engaged in the groove portion 16, so that wild movement (such as unintended positional deviation or bending) or slack of the harness 15 is suppressed, so that an assembling property can be improved.

In a state in which the harness 15 is mounted to the optical scanning apparatus, the small lid 17 as a cover member (sealing member) for closing the through hole 14 is mounted to the lid 13. In the case where the small lid 17 is viewed along the rotational axis direction of the rotational polygonal mirror 4, the small lid 17 includes a flat plate-like small lid main body 17a having a shape (substantially rectangular shape in this embodiment) equivalent to a shape defined by four side stepped portions 13b provided to the lid 13.

Further, on a surface of this small lid main body 17a facing an inside of the housing 30, a locking portion 18 projected so as to approach toward the bottom 10a of the optical box 10 along the rotational axis direction of the rotational polygonal mirror 4 is provided. In this embodiment, the locking portion 18 is provided inside each of two sides corresponding to the stepped portions 13b extending along the main scanning direction in the small lid main body 17a. Further, the small lid 17 is engaged with the lid 13 so as to be mounted on the stepped portions 13b. At this time, the locking portions 18 are engaged with engaging portions (edges of the stepped portions 13b or the like) on the lid 13 side by snap-fit engagement. By this, the small lid 17 is fitted to the lid 13 simply and stably.

Further, in this embodiment, on the surface of the small lid main body 17a provided with the above-described locking portions 18, a rib 17b projected so as to approach toward the bottom 10a of the optical box 10 along the rotational axis direction of the rotational polygonal mirror 4 is provided. In this embodiment, the rib 17b is provided inside each of two sides corresponding to the stepped portions 13b extending along the direction substantially perpendicular to the main scanning direction. The ribs 17b may be formed so as to contact side surfaces of the stepped portions 13b (so as to contact the harness 15 in a position where the harness 15 is disposed), and are capable of improving a sealing property of the through hole 14 by the small lid 17 and mounting operability of the small lid 17 to the lid 13. Although the small lid 17 is fixed to the lid 13 so as to be substantially brought into close contact with the lid 13, a slight gap is formed between itself and the groove portion 16 (and the cut-away portion 13c). For that reason, the harness 15 is passed through the slight gap, so that the small lid 17 can be fixed to the lid 13 without causing wire biting. Further, the small lid 17 is fixed to the lid 13 so as to be substantially brought into close contact with the lid 13, and therefore, dust is suppressed from entering the inside of the housing 30 through the through hole 14, so that it is possible to suppress that the respective optical members inside the housing 30 are contaminated.

Incidentally, a fixing means for fixing the small lid 17 to the lid 13 is not limited to the snap-fit engagement. As this fixing means, arbitrary fixing means such as engagement, bonding, welding, and fastening can be used singly or in combination of a plurality of these means. Further, the shape of the through hole 14 is not limited to the rectangular shape, but may also be an arbitrary polygonal shape or the like including a circle, an ellipse, and a rectangle.

### Effect

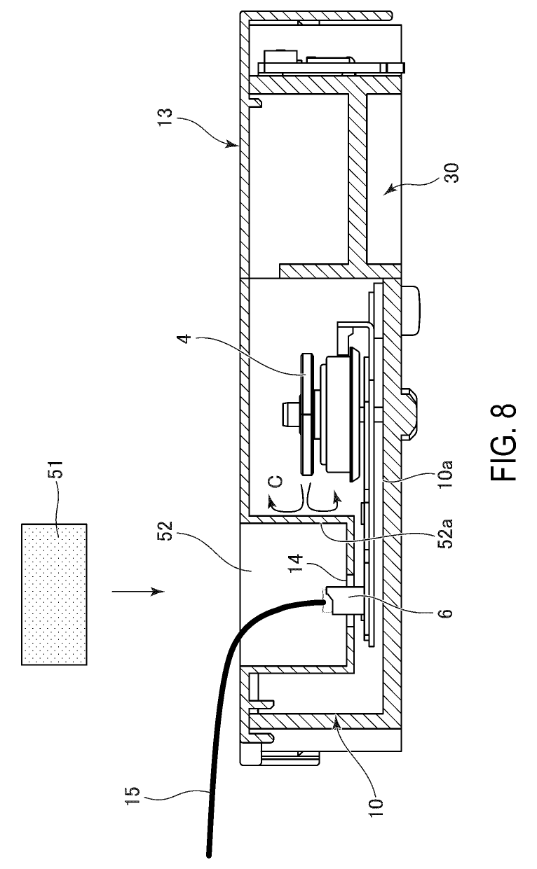

An effect of this embodiment will be described by making comparison between this embodiment and a comparison example. FIG. 4 is a schematic sectional view of the optical scanning apparatus 101 in this embodiment (in which a state such that a cross section cut along the main scanning direction is viewed from a right side in FIG. 2 is shown). Further, FIG. 8 is a schematic sectional view of an optical scanning apparatus 101 in a comparison example according to a constitution disclosed in Japanese Patent No. 6433118 (in which a cross section similar to FIG. 2 is shown).

Incidentally, also as regards the comparison example, elements having identical or corresponding functions or constitutions to those in this embodiment will be described by adding thereto the same reference numerals or symbols.

First, a problem in the constitution of the comparison example shown in FIG. 8 will be described. In the constitution of the comparison example, similarly as in the constitution of this embodiment, a lid 13 is provided with a through hole 14 so that a harness 15 can be connected to a connector 6 of a light deflector 5 in a state in which the lid 13 is connected to an optical box 10. Further, in the constitution of the comparison example, the lid 13 is provided with a mounting portion 52 for mounting an elastic member 51 for protection against dust. The through hole 14 is provided in a bottom of the mounting portion 52. The mounting portion 52 is recessed so as to approach toward a bottom 10a of the optical box 10, and the elastic member 51 is engaged in this mounting portion 52, so that the elastic member 51 is mounted outside the through hole 14. However, in recent years, due to downsizing of the light deflector 5, there is a tendency that an interval between a rotational polygonal mirror 4 and the connector 6 becomes narrow. For this reason, in a state in which the lid 13 is mounted to the optical box 10, a distance between a wall 52a constituting the mounting portion 52 and the rotational polygonal mirror 4 becomes close. The rotational polygonal mirror 4 is rotated at a high speed, and therefore, air (wind) is generated radially from a rotation center toward an outside. This air is blown against the wall 52a at a high speed, so that a vortex of the air is generated in the neighborhood of the wall 52a as shown by arrow C in FIG. 8. By this vortex, pressure of the air is changed, and the air is vibrated, so that wind noise is generated. In general, when a wall, a stepped portion, or a projection is present with respect to an air (air stream) traveling direction, the air stream is disturbed in a position thereof, so that the vortex is generated. Also, in the constitution of the comparison example, the mounting portion 52 constitutes an obstacle to the air stream, and therefore, the vortex of the air as shown by the arrow C in FIG. 8 is generated, thus leading to generation of the wind noise.

On the other hand, in the constitution of this embodiment shown in FIG. 4, with a rotation locus flat plane E of the rotational polygonal mirror 4 as a boundary, the through hole 14 is disposed on a side opposite from the bottom 10a of the optical box 10 in the rotational axis direction of the rotational polygonal mirror 4. Here, the rotation locus flat plane E of the rotational polygonal mirror 4 is a flat plane passing through a center portion of the reflecting surface F of the rotational polygonal mirror 4 in the rotational axis direction and substantially perpendicular to the rotational axis direction of the rotational polygonal mirror 4. Particularly, in this embodiment, the lid 13 has the outer surface (first surface) 13a and a second surface 13d constituting the stepped portion 13b and provided with the through hole 14, and in the rotational axis direction of the rotational polygonal mirror 4, the second surface 13d is disposed in a position which is a position different from a position of the first surface 13a and which is between the first surface 13a and the rotation locus flat plane E.

Further, the small lid 17 is disposed on the stepped portion 13b from an outside of the through hole 14. That is, in the constitution of this embodiment, with the rotation locus flat plane E of the rotational polygonal mirror 4 as the boundary, the small lid 17 is also disposed on a side opposite from the bottom 10a of the optical box 10 in the rotational axis direction of the rotational polygonal mirror 4. Incidentally, with the rotation locus flat plane E of the rotational polygonal mirror 4 as the boundary, the small lid 17 is disposed as a whole, including the small lid main body 17a, and the locking portions 18 and the ribs 17b which are provided to the small lid main body 17a, on the side opposite from the bottom 10a of the optical box 10 in the rotational axis direction of the rotational polygonal mirror 4. Accordingly, in the constitution of this embodiment, on the rotation locus flat plane E of the rotational polygonal mirror 4, between a position of the rotational axis G of the rotational polygonal mirror 4 and a position of the connector 6 in the direction substantially perpendicular to the rotational axis direction of the rotational polygonal mirror 4, the lid 13 and the small lid 17 are not present. For that reason, although the air (wind) is generated as shown by the arrow D in FIG. 4, there is no wall against which the air is blown immediately after being generated, and therefore, the vortex of the air as in the constitution of the comparison example shown in FIG. 8 is not generated, so that the wind noise can be remarkably suppressed.

Thus, in this embodiment, the optical scanning apparatus 101 includes the light deflector 5 provided with the rotatable rotational polygonal mirror having the reflecting surface F for reflecting the laser light, the casing (optical box) 10 which is the casing 10 for accommodating the light deflector 5 and which is provided with the bottom 10a supporting the light deflector 5 and the open portion 10b on the side surface opposite from the bottom 10a in the rotational axis direction of the rotational polygonal mirror 4, the lid 13 for covering the open portion 10b of the casing 10, and the connecting portion (connector) 6 to which the electric wire (harness) 15 is connected. Further, in this embodiment, the lid 13 is provided with the opening (through hole) 14 which is the opening 14 through which the electric wire 15 passes and which enables connection of the electric wire 15 to the connecting portion 6 in the state in which the lid 13 is mounted to the casing 10, and when a flat plane passing through the reflecting surface F of the rotational polygonal mirror 4 and substantially perpendicular to the rotational axis direction of the rotational polygonal mirror 4 is the rotation locus flat plane E, the opening 14 is positioned on a side opposite from the bottom 10a of the casing 10 with respect to the rotation locus flat plane E in the rotational axis direction of the rotational polygonal mirror 4. In this embodiment, the lid 13 includes the outer surface 13a (first surface) thereof and the second surface 13d provided with the opening 14, and the second surface 13d is positioned between the first surface 13a and the rotation locus flat plane E in the rotational axis direction of the rotational polygonal mirror 4. Further, in this embodiment, the optical scanning apparatus 101 includes the cover member (small lid) 17 for covering the opening 14, and the cover member 17 is positioned on the side opposite from the bottom 10a of the casing 10 with respect to the rotation locus flat plane E in the rotational axis direction of the rotational polygonal mirror 4. Further, in this embodiment, the lid 13 is provided with the groove portion 16 through which the electric wire 15 pulled out from between the lid 13 and the cover member 17 is capable of being passed. Further, in this embodiment, the cover member 17 is constituted by the resin mold member and is fixed to the lid by being engaged with the lid 13. Further, according to this embodiment, the image forming apparatus 100 including the photosensitive member (photosensitive drum) 102, and the above-described optical scanning apparatus 101 for scanning the photosensitive member 102 with the light and for exposing the photosensitive member 102 to the light. This image forming apparatus 100 includes the output portion (circuit board) 115 for outputting the signal to the optical scanning apparatus 101 and the electric wire 15 for transmitting the signal, from the output portion 115, to the optical scanning apparatus 101.

As described above, according to this embodiment, the vortex of the air due to the wind generated by the rotation of the rotational polygonal mirror 4 is suppressed from being generated, so that the wind noise can be remarkably suppressed. That is, according to this embodiment, the lid 13 and further the small lid 17 covering the through hole 14 are not disposed on the rotation locus flat plane E of the rotational polygonal mirror 4. For that reason, the wind generated by the rotation of the rotational polygonal mirror 4 does not collide with a part of the small lid 17 immediately after generation thereof. By this, it is possible to suppress the wind noise generated by the rotation of the rotational polygonal mirror 4. Thus, according to this embodiment, the wind noise by the rotation of the rotational polygonal mirror 4 can be suppressed by ensuring a sufficient space around the rotational polygonal mirror 4 while maintaining a dust-proof performance. Accordingly, according to this embodiment, in the constitution in which the harness 15 is passed through the lid 13 of the optical box 10, it is possible to suppress the wind noise due to the rotation of the rotational polygonal mirror 4.

### Embodiment 2

Next, another embodiment of the present disclosure will be described. Basic constitution and operation of an image forming apparatus of this embodiment are the same as those of the image forming apparatus of the embodiment 1. Accordingly, in the image forming apparatus of this embodiment, elements having identical or corresponding functions or constitutions to those of the image forming apparatus of the embodiment 1 will be omitted from detailed description by adding thereto the same reference numerals or symbols as those in the embodiment 1.

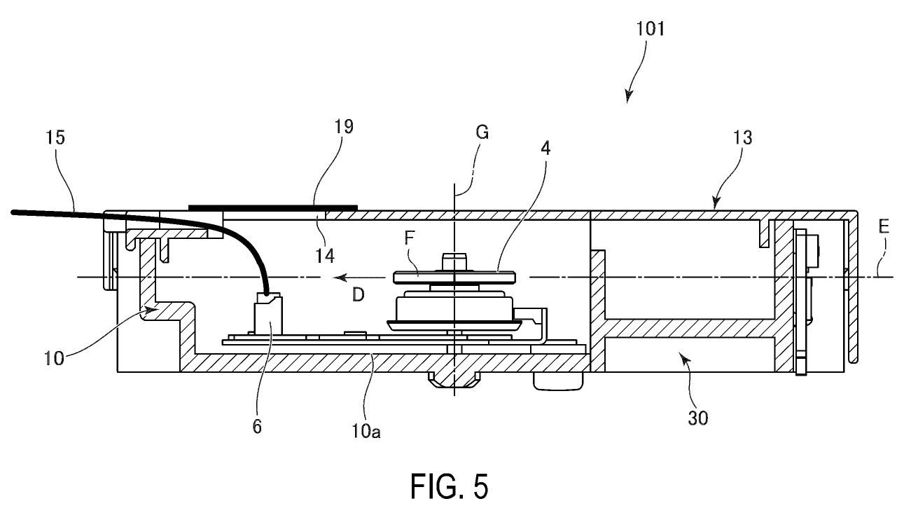

FIG. 5 is a schematic sectional view of the optical scanning apparatus 101 in this embodiment. In the embodiment 1, the cover member for covering the through hole 14 provided in the lid 13 of the optical box 10 was constituted by the small lid 17 which is the resin mold member (member prepared by molding with resin). On the other hand, in this embodiment, the cover member is constituted by a sheet-like seal member 19.

The seal member 19 has an area larger than an opening area of a through hole 14, and is stuck on an outer surface 13a of the lid 13 constituting an edge of the through hole 14. The seal member 19 can be constituted by a film (or tape) provided with a layer of a tackiness agent (or adhesive) on a surface of the lid 13 on a side where the seal member 19 is stuck. Thus, the cover member may be constituted by a sheet-like seal member 19, and the seal member 19 is fixed to the lid 13 by being stuck to the lid 13.

Also, in this embodiment, similarly as the embodiment 1, with the rotation locus flat plane E of the rotational polygonal mirror 4 as the boundary, the through hole 14 is disposed on a side opposite from the bottom 10a of the optical box 10 in the rotational axis direction of the rotational polygonal mirror 4. Further, the seal member 19 is stuck from an outside of the through hole 14 to the outer surface 13a. Thus, also by using the seal member 19 for sealing the through hole 14, a constitution in which on the rotation locus flat plane E of the rotational polygonal mirror 4, there is no wall between a position of the rotational axis G of the rotational polygonal mirror 4 and a position of the connector 6 can be provided. For this reason, according to this embodiment, an effect similar to that of the embodiment 1 can be obtained.

### Embodiment 3

Next, another embodiment of the present disclosure will be described. Basic constitution and operation of an image forming apparatus of this embodiment are the same as those of the image forming apparatus of the embodiment 1. Accordingly, in the image forming apparatus of this embodiment, elements having identical or corresponding functions or constitutions to those of the image forming apparatus of the embodiment 1 will be omitted from detailed description by adding thereto the same reference numerals or symbols as those in the embodiment 1.

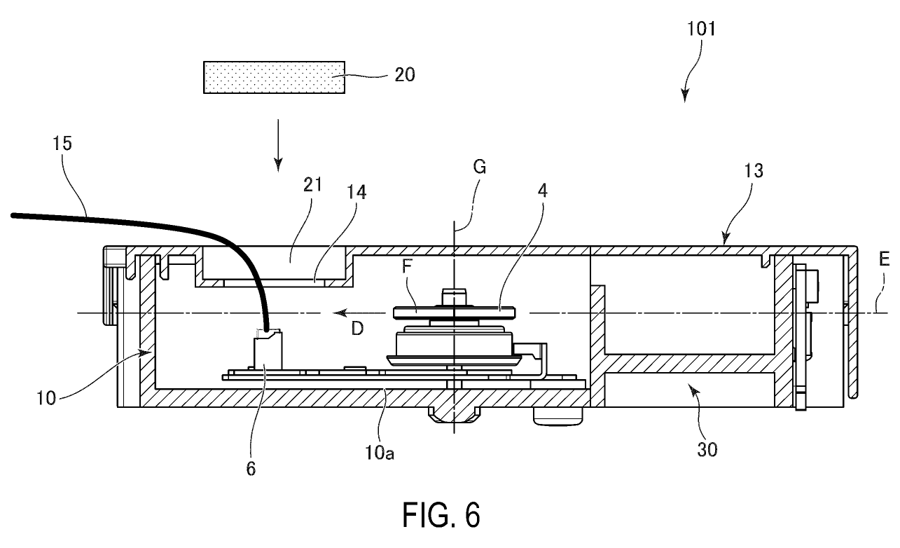

FIG. 6 is a schematic sectional view of the optical scanning apparatus 101 in this embodiment. The cover member for covering the through hole 14 provided in the lid 13 of the optical box 10 was constituted by the small lid 17 which is the resin mold member in the embodiment 1, and was constituted by the sheet-like seal member 19 in the embodiment 2. On the other hand, in this embodiment, the cover member is constituted by an elastic member 20.

In this embodiment, similarly as in the constitution of the above-described comparison example shown in FIG. 8, the lid 13 is provided with a mounting portion 21 which is a recessed portion to which the elastic member 20 for suppressing flowing-in of the air contaminated with dust or the like into the housing 30 through the through hole 14 is mounted. The through hole 14 is provided in a bottom of the mounting portion 21. The mounting portion 21 is recessed so as to approach toward the bottom 10a of the optical box 10, and the elastic member 20 is engaged in this mounting portion 21, so that the elastic member 20 is mounted to an outside of the through hole 14. Thus, in this embodiment, the lid 13 is provided with a recessed portion (mounting portion) 21 so as to approach toward the bottom 10a of the casing 10. The opening (through hole) 14 is provided in the bottom of the recessed portion 21, and the cover member 20 is constituted by the elastic member and is engaged in the recessed portion 21.

However, in this embodiment, different from the constitution of the comparison example shown in FIG. 8, the mounting portion 21 including the through hole 14 is not disposed on the rotation locus flat plane E of the rotational polygonal mirror 4. That is, also, in this embodiment, similarly as the embodiment 1, with the rotation locus flat plane E of the rotational polygonal mirror 4 as the boundary, the through hole 14 is disposed on a side opposite from the bottom 10a of the optical box 10 in the rotational axis direction of the rotational polygonal mirror 4. Further, the elastic member 20 is mounted to the outside of the through hole 14 by being engaged in the mounting portion 21. Thus, in this embodiment, on the rotation locus flat plane E of the rotational polygonal mirror 4, there is no wall between a position of the rotational axis G of the rotational polygonal mirror 4 and a position of the connector 6 can be provided. For this reason, in the constitution of this embodiment, the vortex of the air as in the constitution of the comparison example shown in FIG. 8 is suppressed from being generated. Accordingly, according to this embodiment, an effect similar to that of the embodiment 1 can be obtained.

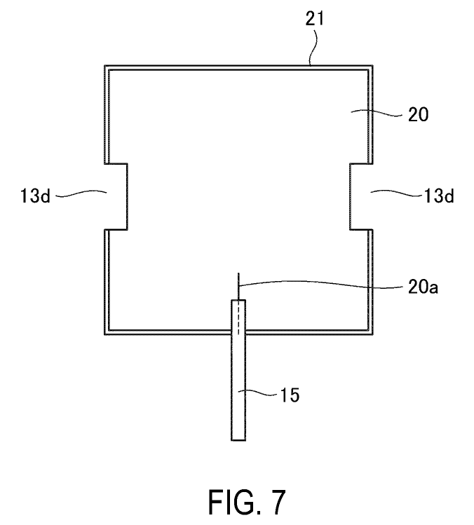

Incidentally, the elastic member 20 can be constituted by a foam member such as a rubber or urethane or the like. Further, each of dimensions of the mounting portion 21 in the main scanning direction and in a direction substantially perpendicular to the main scanning direction is made a dimension somewhat smaller than a dimension of the elastic member 20 in an associated direction, so that the elastic member 20 can be mounted to the mounting portion 21 in a compressed state. Further, as shown in FIG. 7, the elastic member 20 can be provided with a cut-away portion 20a through which the harness 15 is passed. Further, as shown in FIG. 7, the lid 13 may be provided with restricting portions 13d for restricting movement of the elastic member 20 in a direction in which the elastic member 20 is demounted from the mounting portion 21. Further, the elastic member 20 may be fixed to the mounting portion 21 by an arbitrary fixing means such as bonding or welding.

### Other embodiments

In the above, the present disclosure was described based on specific embodiments, but the present disclosure is not limited to the above-described embodiments.

In the above-described embodiments, the present disclosure is applied to the monochromatic image forming apparatus, but the present disclosure is also applicable to a color image forming apparatus. In the case where an image forming apparatus includes a plurality of optical scanning apparatuses, the present disclosure is applicable to at least one of these optical scanning apparatuses.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-066553, filed on Apr. 14, 2025, which is hereby incorporated by reference herein in its entirety.

What is claimed is:

1. An optical scanning apparatus comprising:
a light deflector configured to deflect laser light emitted from a light source, the light deflector including a rotatable polygonal mirror having a reflecting surface for reflecting the laser light, a motor for driving the rotatable polygonal mirror, a substrate on which an electric circuit for driving the motor is formed and on which the motor is mounted, and a connecting portion to which an electric wire is connected;
a casing configured to accommodate the light deflector, the casing including a bottom for supporting the light deflector and an open portion opposing the bottom in a rotational axis direction of the rotatable polygonal mirror; and
a lid configured to cover the open portion of the casing,
wherein the lid is provided with an opening through which the electric wire passes and which enables connection of the electric wire to the connecting portion in a state in which the lid is mounted to the casing, and
wherein when a central portion of the reflecting surface of the rotatable polygonal mirror in the rotational axis direction, which is a flat plane perpendicular to the rotational axis direction is a rotation locus flat plane, the opening is positioned on a side opposite from the bottom of the casing in the rotational axis direction with the rotation locus flat plane as a boundary.

2. The optical scanning apparatus according to claim 1, wherein the lid includes a first surface which is a flat surface constituting an outer surface of the lid and a second surface which is a surface of a region of the lid where the opening is provided and which constitutes an inner surface of the lid, and
wherein the second surface is positioned between the first surface and the rotation locus flat plane in the rotational axis direction of the rotational polygonal mirror.

3. The optical scanning apparatus according to claim 1, further comprising a cover member configured to cover the opening,
wherein in the rotational axis direction of the rotational polygonal mirror, the cover member is positioned on a side opposite from the bottom of the casing with respect to the rotation locus flat plane.

4. The optical scanning apparatus according to claim 3, wherein the lid is provided with a groove portion through which the electric wire pulled out from between the lid and the cover member is capable of being passed.

5. The optical scanning apparatus according to claim 3, wherein the cover member is constituted by a resin molding member and is fixed to the lid by being engaged with the lid.

6. The optical scanning apparatus according to claim 3, wherein the cover member is constituted by a sheet-like seal member and is fixed to the lid by being stuck to the lid.

7. The optical scanning apparatus according to claim 3, wherein the lid is provided with a recessed portion recessed so as to approach toward a bottom of the casing,
wherein the opening is provided in a bottom of the recessed portion, and
wherein the cover member is constituted by an elastic member and is fitted into the recessed portion.

8. An image forming apparatus comprising:
a photosensitive member;
an optical scanning apparatus according to claim 1; and
an output portion configured to output a signal to the optical scanning apparatus and to which the electric wire is connected.
